(19) United States
(12) Patent Application Publication
(10) Pub. No.: US 2017/0175576 A1
(43) Pub. Date: Jun. 22, 2017

(54) SYSTEM AND METHOD FOR UTILIZING TARGET FEATURES IN FORMING INLET PASSAGES IN MICRO-CHANNEL CIRCUIT

(71) Applicant: General Electric Company, Schenectady, NY (US)

(72) Inventors: Marc Lionel Benjamin, Taylors, SC (US); Gregory Thomas Foster, Greer, SC (US); Benjamin Paul Lacy, Greer, SC (US); Thomas James Brunt, Greenville, SC (US); San Jason Nguyen, Simpsonville, SC (US)

(21) Appl. No.: 14/971,724

(22) Filed: Dec. 16, 2015

(51) Int. Cl. F01D 25/12; F01D 9/04; F01D 25/24; F02C 3/04; F02C 7/18

(52) U.S. Cl. CPC F01D 25/12; F02C 3/04; F02C 7/18; F01D 25/246; F01D 9/04; F05D 2220/32; F05D 2240/35; F05D 2250/14

(57) ABSTRACT

A shroud segment for use in gas turbines, includes a body, leading edge, trailing edge, a first and second side edge, and a pair of opposed lateral sides between the leading and trailing edges and the first and second side edges. A first lateral side of the lateral sides interface with a cavity having a cooling fluid. A second lateral side interfaces with a hot gas flow path. A first channel disposed within the body includes a first and second end portion. A second channel is disposed within the body includes a third and fourth end portion. The first and second channels receive the cooling fluid from the cavity to cool the body. The first and fourth end portion have portions with free ends having a width greater than an adjacent portion coupled to the free end.

### BACKGROUND

The subject matter disclosed herein relates to gas turbine engines, and more specifically, to turbine shrouds for gas turbine engines.

A turbomachine, such as a gas turbine engine, may include a compressor, a combustor, and a turbine. Gases are compressed in the compressor, combined with fuel, and then fed into to the combustor, where the gas/fuel mixture is combusted. The high temperature and high energy exhaust fluids are then fed to the turbine along a hot gas path, where the energy of the fluids is converted to mechanical energy. High temperatures along the hot gas path can heat turbine compoments (e.g., turbine shroud), causing degradation of components.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system includes a shroud segment for use in a turbine section of a gas turbine engine, including a body including a leading edge, a trailing edge, a first side edge, and a second side edge, a pair of opposed lateral sides between the leading and trailing edges and the first and second side edges. The system includes a first lateral side of the pair of opposed lateral sides which interfaces with a cavity having a cooling fluid. The system also includes a second lateral side of the pair of opposed lateral sides which interfaces with a hot gas flow path, a first channel disposed within the body, where the first channel includes a first end portion and a second end portion. The first end portion is disposed adjacent the first side edge and the second end portion is disposed adjacent the second side edge. The system also includes a second channel disposed within the body, where the second channel includes a third end portion and a fourth end portion. The third end portion is disposed adjacent the first side edge and the fourth end portion is disposed adjacent the second side edge. The first and second channels receive the cooling fluid from the cavity to cool the body, and the first end portion and the fourth end portion each include a portion having a free end. Each free end has width in a direction from the leading edge to the trailing edge greater than an adjacent portion of the portion coupled to the free end.

In a second embodiment, an apparatus includes a gas turbine engine, including a compressor, a combustion system, and a turbine section. The apparatus includes a casing, an outer shroud segment coupled to the outer casing, an inner shroud segment coupled to the outer shroud segment to form a cavity configured to receive a discharged cooling fluid from the compressor. The inner shroud segment includes a body having a leading edge, a trailing edge, a first side edge, and a second side edge, a pair of opposed lateral sides between the leading and trailing edges and the first and second side edges, where a first lateral side of the pair of opposed lateral sides is configured to interface with the cavity, and a second lateral side of the pair of opposed lateral sides is configured to interface with a hot gas flow path. The apparatus also includes a plurality of channels disposed within the body and extending from adjacent the first side edge to adjacent the second side edge, wherein each channel of the plurality of channels comprises a first end portion having a portion and a second end portion. The plurality of channels are configured to receive a cooling fluid from the cavity to cool the body. The first end portions each comprises a portion having a free end, and each free end has a width in a direction from the leading edge to the trailing edge greater than an adjacent portion of the portion coupled to the free end.

In a third embodiment, a system includes a shroud segment for use in a turbine section of a gas turbine engine. The system includes a body including a leading edge, a trailing edge, a first side edge, a second side edge, and a pair of opposed lateral sides between the leading and trailing edges and the first and second side edges. A first lateral side of the pair of opposed lateral sides is configured to interface with a cavity having a cooling fluid, and a second lateral side of the pair of opposed lateral sides is configured to interface with a hot gas flow path. A first channel is disposed within the body, and the first channel includes a first end portion and a second end portion. The first end portion is disposed adjacent the first side edge and the second end portion is disposed adjacent the second side edge. A second channel is disposed within the body, and the second channel comprises a third end portion and a fourth end portion. The third end portion is disposed adjacent the first side edge and the fourth end portion is disposed adjacent the second side edge. The first and second channels are configured to receive the cooling fluid from the cavity to cool the body, and the first end portion and the fourth end portion each include a portion having a free end. The free end has an elliptic shape and a straight portion adjacent the free end.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a block diagram of an embodiment of a turbine system having a turbine shroud with cooling channels;

FIG. 2 is a perspective view of an embodiment of an inner turbine shroud segment coupled to an outer turbine shroud segment;

FIG. 3 is a bottom view (e.g., view of lateral side that is oriented toward a hot gas flow path) of an embodiment of an inner turbine shroud segment;

FIG. 4 is a top view (e.g., view of lateral side that interfaces with a cavity) of an embodiment of an inner turbine shroud segment;

FIG. 5 is a perspective cross-sectional view of an embodiment of a portion of the inner turbine shroud segment of FIG. 4, taken along line 5-5 (with inlet passages and channels shown in dashed lines);

FIG. 6 is a perspective view of an embodiment of a portion of an inner turbine shroud segment;

FIG. 7 is a bottom view of an embodiment of the inner turbine shroud segment, taken within line 7-7 of FIG. 3; and

FIG. 8 is a flow chart of an embodiment of a method for manufacturing an inner turbine shroud segment.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, certain embodiments of turbine shrouds associated with gas engines reduce the hot gas leaks between the pressure side and the suction side of a turbine blade. The turbine shrouds also provide cooling flows (e.g., air) to the turbine blade to reduce premature failure of the blade and associated blade components or may cool areas between adjacent shrouds. The turbine shrouds as described herein utilize multiple cooling channels. The cooling channels may be formed on either side of a shroud body (e.g., inner shroud segment or outer shroud segment). The cooling channels may be machined into the shroud body via a suitable process, such as electrical discharge machining, which helps control the pressure drop across the cooling channel (e.g., by producing consistently sized exit hole diameters). The cooling channels also include free ends disposed on the hook portion. The free ends (e.g., targets) couple to the inlet passages to receive the cooling fluid. The target features enable the inlet passages (e.g., forming feedholes) to intersect the channels, thereby improving cooling of the shroud segments. The inlet passages and the free ends (e.g, targets) are aligned and exit metering holes are electrical discharge machined such that the inlet passages may receive a cooling flow (e.g., air). As described in detail below, multiple cooling channels (e.g., a first channel, a second channel) may be disposed on the shroud segment. The inner shroud segment may include a shroud body having a leading edge and a trailing edge. The body has a first side edge and a second side edge. A pair of opposed lateral sides may be disposed between the leading edge and the trailing edge. The opposed lateral sides may be described as a first lateral side and a second lateral side. The first lateral side (e.g., a bottom side of shroud body) interfaces with a cavity defined by the inner shroud segment and the outer shroud segment. The outer shroud segment is coupled to the inner shroud segment. The second lateral side (e.g., outermost side of shroud body) may be configured to interface with a hot gas flow path (e.g., exhaust gases).

The first channel includes a first end portion and a second end portion, disposed adjacent the first side edge and adjacent the second side edge, respectively. The second channel is disposed within the shroud body and includes a third end portion and a fourth end portion. The third end portion and the fourth end portions are disposed adjacent the first side edge and adjacent the second side edge, respectively. The first and second channels receive a cooling fluid (e.g., air) from the cavity formed between the first lateral side and the second lateral side. The cooling fluid cools the shroud body and the space between adjacent shrouds as it flows through the cooling channels. Both the first end portion and the fourth end portion include a portion having a free end (e.g., target). The free end (e.g., target) may have a width in a direction from the leading edge to the training edge greater than an adjacent portion of the portion that is coupled to the free end. The end portions may include target features that enable the inlet passage to intersect the cooling channels to receive the cooling fluid, thereby improving cooling of the shroud segments.

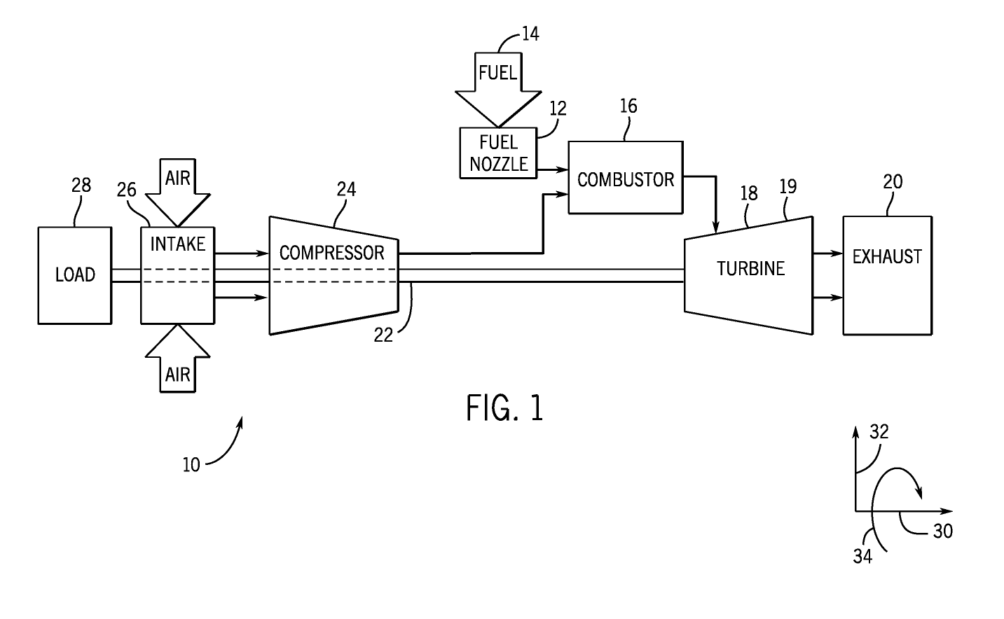

Turning to the drawings, FIG. 1 is a block diagram of an embodiment of a turbine system 10. As described in detail below, the disclosed turbine system 10 (e.g., a gas turbine engine) may employ a turbine shroud having cooling channels, described below, which may reduce the stress modes in the hot gas path components and improve the efficiency of the turbine system 10. The turbine system 10 may use liquid or gas fuel, such as natural gas and/or a hydrogen rich synthetic gas, to drive the turbine system 10. As depicted, fuel nozzles 12 intake a fuel supply 14, mix the fuel with an oxidant, such as air, oxygen, oxygen-enriched air, oxygen reduced air, or any combination thereof. Although the following discussion refers to the oxidant as the air, any suitable oxidant may be used with the disclosed embodiments. Once the fuel and air have been mixed, the fuel nozzles 12 distribute the fuel-air mixture into a combustor 16 in a suitable ratio for optimal combustion, emissions, fuel consumption, and power output. The turbine system 10 may include one or more fuel nozzles 12 located inside one or more combustors 16. The fuel-air mixture combusts in a chamber within the combustor 16, thereby creating hot pressurized exhaust gases. The combustor 16 directs the exhaust gases (e.g., hot pressurized gas) through a transition piece into a turbine nozzle (or “stage one nozzle”), and other stages of buckets (or blades) and nozzles causing rotation of a turbine 18 within a turbine casing 19 (e.g., outer casing). The exhaust gases flow toward an exhaust outlet 20. As the exhaust gases pass through the turbine 18, the gases force turbine buckets (or blades) to rotate a shaft 22 along an axis of the turbine system 10. As illustrated, the shaft 22 may be connected to various components of the turbine system 10, including a compressor 24. The compressor 24 also includes blades coupled to the shaft 22. As the shaft 22 rotates, the blades within the compressor 24 also rotate, thereby compressing air from an air intake 26 through the compressor 24 and into the fuel nozzles 12 and/or combustor 16. A portion of the compressed air (e.g., discharged air) from the compressor 24 may be diverted to the turbine 18 or its components without passing through the combustor 16. The discharged air (e.g., cooling fluid) may be utilized to cool turbine components such as shrouds and nozzles on the stator, along with buckets, disks, and spacers on the rotor. The shaft 22 may also be connected to a load 28, which may be a vehicle or a stationary load, such as an electrical generator in a power plant or a propeller on an aircraft, for example. The load 28 may include any suitable device capable of being powered by the rotational output of the turbine system 10. The turbine system 10 may extend along an axial axis or direction 30, a radial direction 32 toward or away from the axis 30, and a circumferential direction 34 around the axis 30. In an embodiment, hot gas components (e.g., turbine shroud, nozzle, etc.) are located in the turbine 18, where hot gases flow across the components causing creep, oxidation, wear, and thermal fatigue of the turbine components. The turbine 18 may include one or more turbine shroud segments (e.g., inner turbine shroud segments) having a cooling passages (e.g., near surface micro-channels) to enable control of the temperature of the hot gas path components (e.g., utilizing less cooling air than typical cooling systems for shrouds) to reduce distress modes in the components, to extend service life of the components (while performing their intended functions), reduce costs associated with operating the turbine system 10, and to improve the efficiency of the gas turbine system 10.

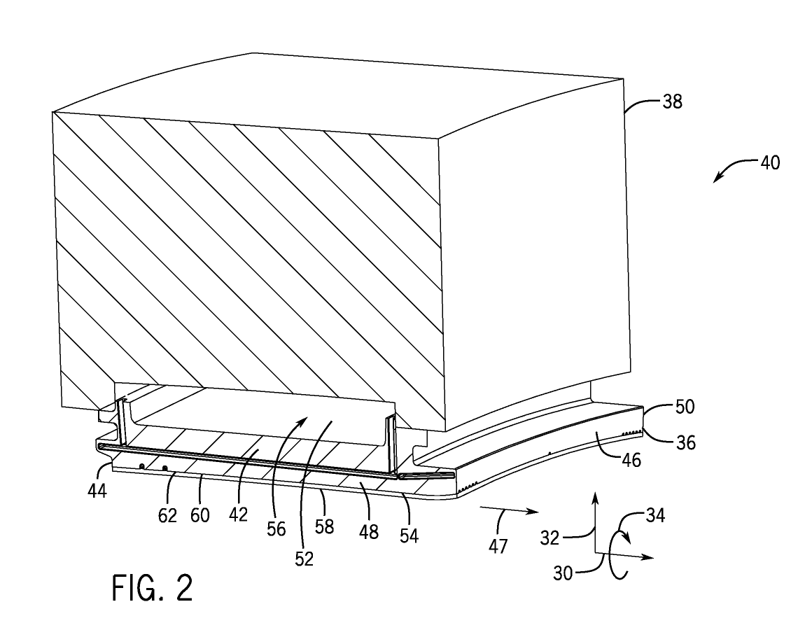

FIG. 2 is a perspective view of an embodiment of an inner turbine shroud segment 36 coupled to an outer turbine shroud segment 38 to form a turbine shroud segment 40. The turbine 18 includes multiple turbine shroud segments 40 that together form a respective ring about respective turbine stages. In certain embodiments, the turbine 18 may include multiple inner turbine shroud segments 36 coupled to respective outer turbine shroud segments 38 for each turbine shroud segment 40 disposed in the circumferential direction 34 about a rotational axis of the turbine 18 (and a turbine stage). In other embodiments, the turbine 18 may include multiple inner turbine shroud segments 38 coupled to the outer turbine shroud segment 38 to form the turbine shroud segment 40.

As depicted, the inner turbine shroud segment 40 includes a body 42 having an upstream or leading edge 44 and a downstream or trailing edge 46 that both interface with a hot gas flow path 47. The body 42 also includes a first side edge 48 (e.g., first slash face) and a second side edge 50 (e.g., second slash face) disposed opposite the first side edge 48 both extending between the leading edge 44 and the trailing edge 46. The body 42 further includes a pair of opposed lateral sides 52, 54 extending between the leading and trailing edges 44, 46 and the first and second side edges 48, 50. In certain embodiments, the body 42 (particularly, lateral sides 52, 54) may be arcuate shaped in the circumferential direction 34 between the first and second side edges 48, 50 and/or in the axial direction 30 between the leading and trailing edges 44, 46. The lateral side 52 is configured to interface with a cavity 56 defined between the inner turbine shroud segment 36 and the outer turbine shroud segment 38. The lateral side 54 is configured to be oriented toward the hot gas flow path 47 within the turbine 18.

As described in greater detail below, the body 42 may include multiple channels (e.g., cooling channels or micro-channels) disposed within the lateral side 54 to help cool the hot gas flow path components (e.g., turbine shroud 40, inner turbine shroud segment 36, etc.). A pre-sintered preform (PSP) layer 58 may be disposed on (e.g., brazed onto) the lateral side 54 so that a first surface 60 of the PSP layer 58 together with the body 42 defines (e.g., enclose) the channels and a second surface 62 of the PSP layer 58 interfaces with the hot gas flow path 47. The PSP layer 58 may be formed of superalloys and brazing material. In certain embodiments, as an alternative to the PSP layer 58 a non-PSP metal sheet may be disposed on the lateral side 54 that together with the body 42 defines the channels. In certain embodiments, the channels may be cast entirely within the body 42 near the lateral side 54. In certain embodiments, as an alternative to the PSP layer 58, a barrier coating or thermal barrier coating bridging may be utilized to enclose the channels within the body 42.

In certain embodiments, the body 42 includes hook portions to enable coupling of the inner turbine shroud turbine segment 36 to the outer turbine shroud segment 38. As mentioned above, the lateral side 52 of the inner turbine shroud segment 36 and the outer turbine shroud segment 38 define the cavity 56. The outer turbine shroud segment 38 is generally proximate to a relatively cool fluid or air (i.e., cooler than the temperature in the hot gas flow path 47) in the turbine 18 from the compressor 24. The outer turbine shroud segment 38 includes a passage (not shown) to receive the cooling fluid or air from the compressor 24 that provides the cooling fluid to the cavity 56. As described in greater detail below, the cooling fluid flows to the channels within the body 42 of the inner turbine shroud segment 36 via inlet passages disposed within the body 42 extending from the lateral side 52 to the channels. Each channel includes a first end portion that includes a hook-shaped portion having a free end and a second end portion. The second end portion may include a metering feature (e.g., a portion of the body 42 extending into the channel) to regulate flow of the cooling fluid within the channel or to reduce blockage of the channel. In certain embodiments, each channel itself (excluding the second end portion) acts as a metering feature (e.g., includes a portion of the body 42 extending into the channel). In other embodiments, inlet passages coupled to the hook-shaped portion may include a metering feature (e.g., portion of the body 42 extending into the inlet passage). In certain embodiments, the channel itself, the second end portion, or the inlet passage, or a combination thereof includes a metering feature. In addition, the cooling fluid exits the channels (and the body 42) via the second end portions at the first side edge 48 and/or the second side edge 50. In certain embodiments, the channels may be arranged in an alternating pattern with a channel having the first end portion disposed adjacent the first side edge 48 and the second end portion disposed adjacent the second side edge 50, while an adjacent channel has the opposite orientation (i.e., the first end portion disposed adjacent the second side edge 50 and the second end portion disposed adjacent the first side edge 48). The hook-shaped portions of the channels provide a larger cooling region (e.g., larger than typical cooling systems for turbine shrouds) by increasing a length of cooling channel adjacent the slash faces while keeping flow at a minimum. In addition, the hook-shaped portion enables better spacing of the straight portions of the channels. The shape of the channels is also optimized to provide adequate cooling in the event of plugged channels. The disclosed embodiments of the inner turbine shroud segment may enable cooling of the inner turbine shroud segment with less air (e.g., than typical cooling systems for turbine shrouds) resulting in reduced costs associated with regards to chargeable air utilized in cooling.

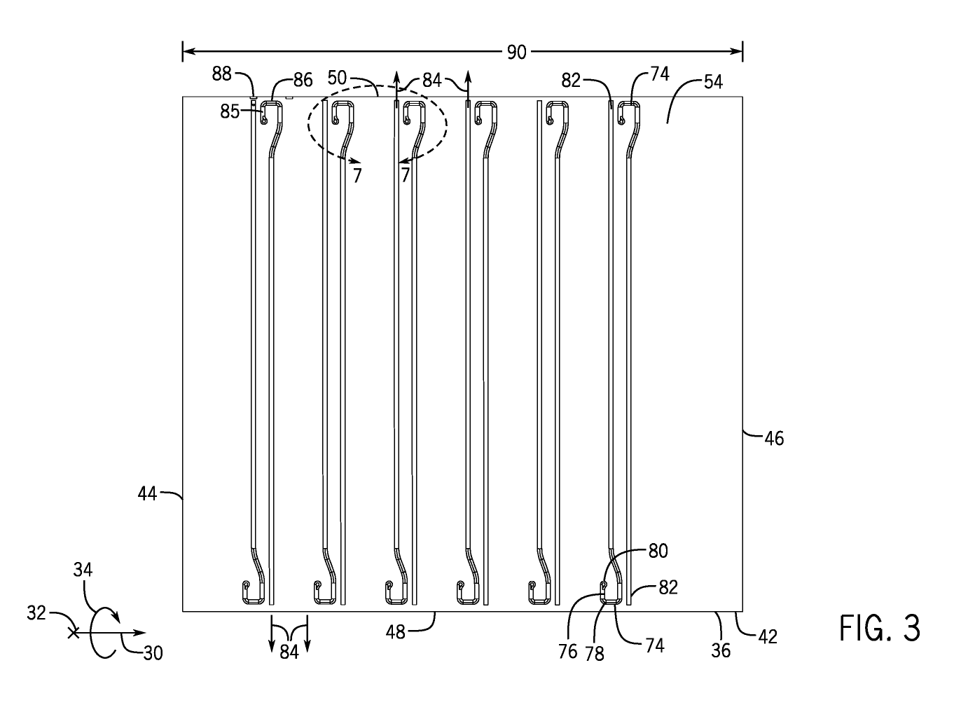

FIG. 3 is a bottom view (e.g., view of the lateral side 54 of the body 42 that is oriented toward hot gas flow path) of an embodiment of the inner turbine shroud segment 36 without the PSP layer 58. As depicted, the body 42 includes a plurality of channels 74 (e.g., cooling channels or micro-channels) disposed within the lateral side 54. The body 42 may include 2 to 40 or more channels 74 (as depicted, the body 42 includes 23 channels 74). Each channel 74 is configured to receive a cooling fluid from the cavity 56. Each channel 74 includes a first end portion 76 that includes a hook-shaped portion 78 having a free end 80. The free end 80 may have an elliptical shape in some embodiments and an adjacent portion near the free end 80 may have a straight shape. Each hook-shaped portion 78 has a hook turn radius ranging from approximately 0.05 to 4 mm, 0.1 to 3 millimeters (mm), 1.14 to 2.5 mm, and all subranges therebetween. As described in greater detail below, the free end 80 of each hook-shaped portion 78 is coupled to inlet passages that enable the channels 74 to receive the cooling fluid from the cavity 56. The curvature of the hook-shaped portion 78 enables more channels 74 to be disposed within the lateral side 54. In addition, the hook-shaped portion 78 provide a larger cooling region (e.g., larger than typical cooling systems for turbine shrouds) by increasing a length of cooling channel 74 adjacent the side edges 48, 50 while keeping flow at a minimum. In addition, the hook-shaped portion 78 enables better spacing of the straight portions of the channels 74. Further, the turning back of the hook-shaped portion 78 enables the straight portions of the channels to be uniformly distant from an adjacent channel to cook the main portion of the body 42 of the shroud segment 36. In certain embodiments, the hook-shaped portion 78 could be adjusted to enable the spacing of the straight portions of the channels 74 to be tighter packed for higher heat load zones. Overall, the shape of the channels 74 is also optimized to provide adequate cooling in the event of plugged channels 74. Each channel 74 also includes a second end portion 82 that enables the spent cooling fluid to exit the body 42 via the side edges 48, 50 via exit holes as indicated by the arrows 84. In certain embodiments, the second end portion 82 includes a metering feature configured to regulate (e.g., meter) a flow of the cooling fluid within the respective channel 74. In certain embodiments, each channel 74 may form a segmented channel at the second end portion 82. In particular, a bridge portion of the body 42 may extend across each channel 74 (e.g., in a direction from the leading edge 44 to the trailing edge 46) within the second end portion 82 with a portion of the channel 74 upstream of the bridge portion and a portion of the channel 74 downstream of the bridge portion. A passage may extend underneath the bridge portion fluidly connecting the portions of the channel 74 upstream and downstream of the bridge portion. In certain embodiments, each channel 74 itself (excluding the second end portion 82) acts as a metering feature (e.g., includes a portion of the body 42 extending into the channel). In other embodiments, inlet passages coupled to the hook-shaped portion 78 may include a metering feature (e.g., portion of the body 42 extending into the inlet passage). In certain embodiments, the channel 74 itself, the second end portion 82, or the inlet passage, or a combination thereof includes a metering feature.

As depicted, some of the channels 74 (e.g., channel 86) include the hook-shaped portion 78 of the first end portion 76 disposed adjacent the side edge 50 and the second end portion 82 disposed adjacent the side edge 48, while some of the channels 74 (e.g., channel 88) include the hook-shaped portion 78 of the first end portion 76 disposed adjacent the side edge 48 and the second end portion 82 disposed adjacent the side edge 50. In certain embodiments, the channels 74 are disposed in an alternating pattern (e.g., channels 86, 88) with one channel 74 having the hook-shaped portion 78 disposed adjacent one side edge 48 or 50 and the second end portion 82 (e.g., in certain embodiments having the metering feature) disposed adjacent the opposite side edge 48 or 50 with the adjacent channel 74 having the opposite orientation. As depicted, the channels 74 extend between the side edges 48, 50 from adjacent the leading edge 44 to adjacent the trailing edge 46. In certain embodiments, the channels 74 may extend between the side edges 48, 50 covering approximately 50 to 90 percent, 50 to 70 percent, 70 to 90 percent, and all subranges therein, of a length 90 of the body 42 between the leading edge 44 and trailing edge 46. For example, the channels 74 may extend between the side edges 48, 50 covering approximately 50, 55, 60, 65, 70, 75, 80, 85, or 90 percent of the length 90. This enables cooling along both of the side edges 48, 50 as well as cooling across a substantial portion of the body 42 (in particular, the lateral side 54 that is oriented toward the hot gas flow path 47) between both the leading edge 44 and the trailing edge 46 and the side edges 48, 50.

The shroud 42 may include multiple cooling channels 74. For example, the illustrated embodiment depicts a first channel 86 and a second channel 88. The first channel 86 includes a first end portion 76 and a second end portion 82. The first end portion 76 may be disposed adjacent the first side edge 48, and the second end portion 82 is disposed adjacent the second side edge 50. The second channel 88 is disposed within the shroud body 42 and includes a third end portion and a fourth end portion. The third end portion is disposed adjacent the first side edge 48, and the fourth end portion is disposed adjacent the second side edge 50. Though the discussion herein describes two cooling channels 74, the shroud body 42 may include 2 to 100, 5 to 50, or 10 to 30 cooling channels and all subranges therebetween.

The first 86 and second 88 channels are configured to receive a cooling fluid (e.g., air) from the cavity to cool the body 42. The first end portion 76 and the fourth end portion 85 each comprises a hook-shaped portion 78 having a free end 80, and each free end has width in a direction from the leading edge 42 to the trailing edge 44 greater than an adjacent portion of the hook-shaped portion 78 coupled to the free end 80. In some embodiments, the hook-shaped portion 78 may have a radius of approximately 0.05 to 4 mm, 0.1 to 3 millimeters (mm), 1.14 to 2.5 mm, and all subranges therebetween. In some embodiments, the hook-shaped portion comprises a depth of approximately 0.05 to 4 mm, 0.1 to 3 mm, 1.27 to 2.5 mm, and all subranges therebetween. The depth of the hook-shaped portion may be less than, greater than, or approximately equal to the radius of the hook-shaped portion 78.

Though the cooling channels 74 described herein are described as having a hook-shaped end portion, the discussion herein is not intended to limit the geometry of the end portions of cooling channels. For example, the cooling channels may utilize any other suitable geometries at the end portions, including a spherical end portion, a rectangular square end portion, an ovular end portion, an elliptical end portion, a square end portion, or any other suitable polygonal shape. The first and fourth end portions 76, 85 include a target portion (e.g., free ends) for the inlet passage to be aligned with. The cooling channel 74 may then be coupled to the target portion (e.g., free ends) to provide a cooling flow across the shroud body 42. The target portions (e.g., free ends) are manufactured to be approximately the same size. For example, the target portions may be approximately constant in diameter. Manufacturing the target portions to be the same size enables the cooling channels to remain substantially free from debris by preventing any one cooling channel from becoming blocked or clogged. The target portions also enable controlled pressure drop and flow of the cooling fluid (e.g., air) through the cooling channels.

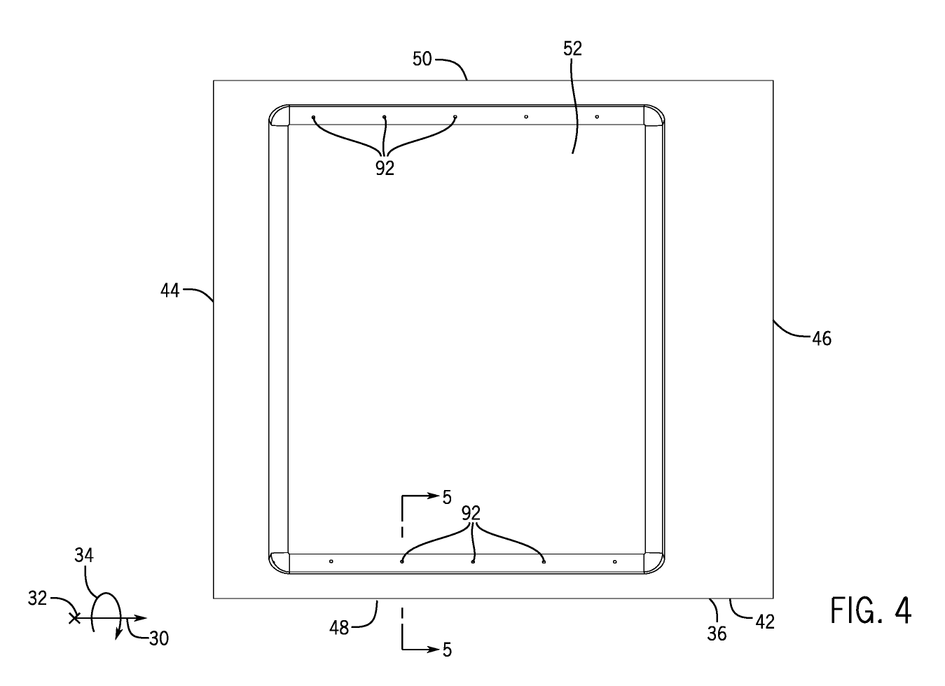

FIG. 4 is a top view (e.g., view of the lateral side 52 that interfaces with the cavity 56) of an embodiment of the inner turbine shroud segment 36. As depicted, the body includes a plurality of opening or apertures 92 that enable cooling fluid to flow from the cavity 56 into the channels 74 via inlet passages. FIG. 5 is a perspective cross-sectional view of an embodiment of the inner turbine shroud segment 36 of FIG. 4, taken along line 5-5. As depicted, inlet passages 94 (shown in dashed lines) extend generally in the radial direction 32 from the free ends 80 of the hook-shaped portions 78 of the channels 74 to the lateral side 52 to enable the flow of cooling fluid into the channels 74. In certain embodiments, the inlet passages 94 may be angled relative to the lateral side 54. For example, an angle of the inlet passages 94 may range between approximately 45 and 90 degrees, 45 and 70 degrees, 70 and degrees, and all subranges therein.

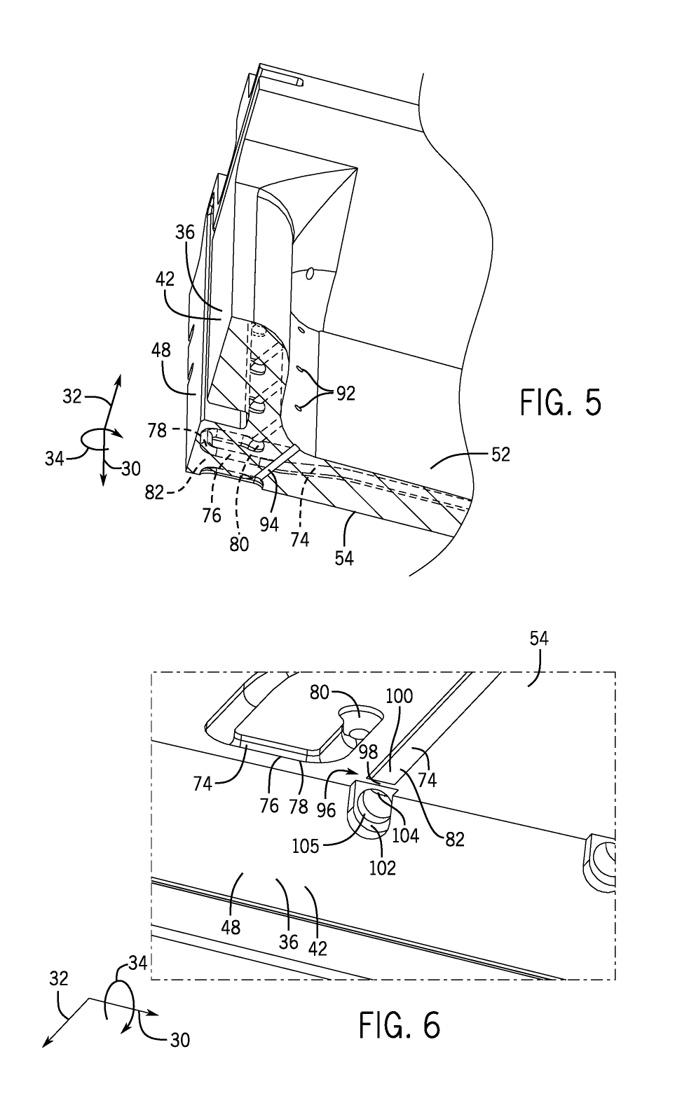

FIG. 6 is a perspective view of a portion of an embodiment of the inner turbine shroud segment 36 (e.g., without the PSP layer 58) illustrating a segmented channel 96 for the second end portion 82 of the channel 74. In certain embodiments, the second end portion 82 includes a metering feature (e.g., bridge portion 98) configured to regulate (e.g., meter) a flow of the cooling fluid within the respective channel 74. In particular, the bridge portion 98 of the body 42 may extend across each channel 74 (e.g., in a direction (e.g., axial direction 30) from the leading edge 44 to the trailing edge 46) within the second end portion 82 to form the segmented 96 with a portion 100 of the channel 74 upstream of the bridge portion 98 and a portion 102 of the channel 74 downstream of the bridge portion 98. The bridge portion 98 may also extend partially into the channel 74 in the radial direction 32. A passage 104 may extend underneath the bridge portion 98 fluidly connecting the portions 100, 102 of the channel 74 upstream and downstream of the channel 74 to enable cooling fluid to exit via exit holes 105. In certain embodiments, each channel 74 itself (excluding the second end portion 82) acts as a metering feature (e.g., includes a portion of the body 42 extending into the channel). In other embodiments, inlet passages 94 coupled to the hook-shaped portion 78 may include a metering feature (e.g., portion of the body 42 extending into the inlet passage). In certain embodiments, the channel 74 itself, the second end portion 82, or the inlet passage 94, or a combination thereof includes a metering feature.

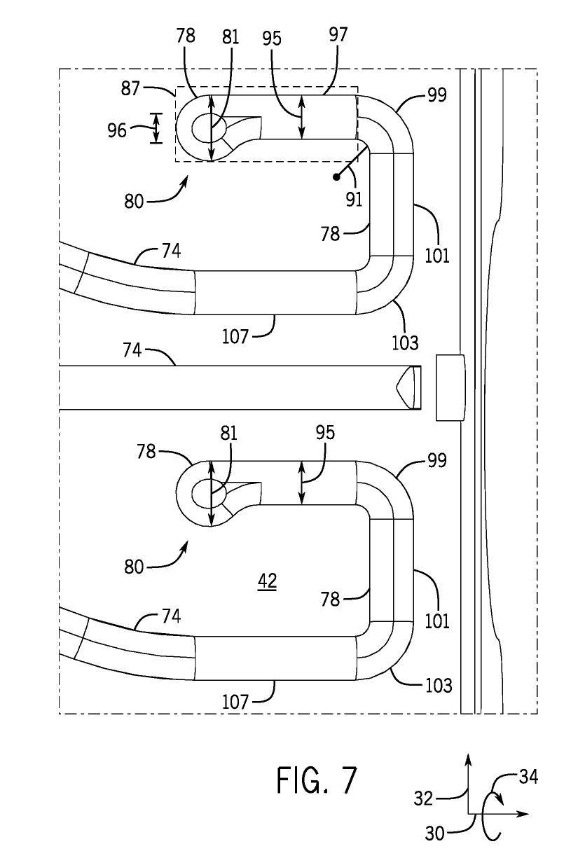

FIG. 7 is a bottom view of an embodiment of the inner turbine shroud segment 36, taken within line 7-7 of FIG. 3. The following discussion as described herein may generally refer to end portions, which may be understood to mean the hook-shaped portions 78 of the passages 74. The hook-shaped portion 78 includes the free end 80. The free end 80 may receive the cooling fluid from the inlet passages 94. Though a hook-shaped portion is illustrated, any suitable shape may be used for the first end portion 76 and the fourth end portion 85 to receive the cooling fluid from the inlet passage 94. As described above, the free end 80 has a width 81 in a direction from the leading edge 44 to the trailing edge 46 greater than a width 95 an adjacent portion (e.g., straight portion) of the hook-shaped portion 78 coupled (e.g., directly) to the free end 80.

The end portion 80 may be elliptical (e.g., circular, oval, etc.) in shape. A substantially straight portion may be disposed adjacent (e.g., immediately downstream) to the free end 80. As described above, the hook-shaped portion 78 may have a radius 91 of approximately 0.05 to 4 mm, 0.1 to 3 mm, 1.14 to 2.5 mm, and all subranges therebetween. The hook-shaped portion 78 comprises a depth (represented by arrow 96) of approximately 0.05 to 4 mm, 0.1 to 3 mm, 1.27 to 2.5 mm, and all subranges therebetween. In some embodiments, the depth 96 of the hook-shaped portion 78 may be less than, greater than, or approximately equal to the radius 91 of the hook-shaped portion 78. It should be appreciated that though the above ranges relating to depth and radius 91 of the hook-shaped portion 78 are described, the ranges are not intended to be limited to the ranges described herein. As described above, the end portions 80 (e.g., hook-shaped portion 78) include target features that enable the inlet passage 94 to intersect the cooling channels 74 to receive the cooling fluid, thereby improving cooling of the shroud segment 36.

The free end 80 couples to a respective inlet passage 94 via the target (e.g., hook portion 78). The inlet passages 94 provide a cooling flow (e.g., cooling fluid, air) from the cavity to the cooling passages 74. In the illustrated embodiment, the width 95 of the straight portion adjacent the hook-shaped portion 78 is smaller than the width 81 of the hook-shaped portion 78. The width 95 of the adjacent portion is shown on a first straight portion 97. The first straight portion 97 is disposed adjacent to a first curved portion 99. The first curved portion 99 is disposed adjacent to a second straight portion 101. The second straight portion 101 is disposed adjacent to a second curved portion 103 that is disposed adjacent to a third straight portion 107. The second straight portion 107 is substantially perpendicular to the second straight portion 101. The first straight portion 97 and third straight portion 103 are substantially parallel to each other. The hook-shaped portion 78 has a portion (represented by arrow 96) that extends in a direction opposite direction 32 from a plane 87.

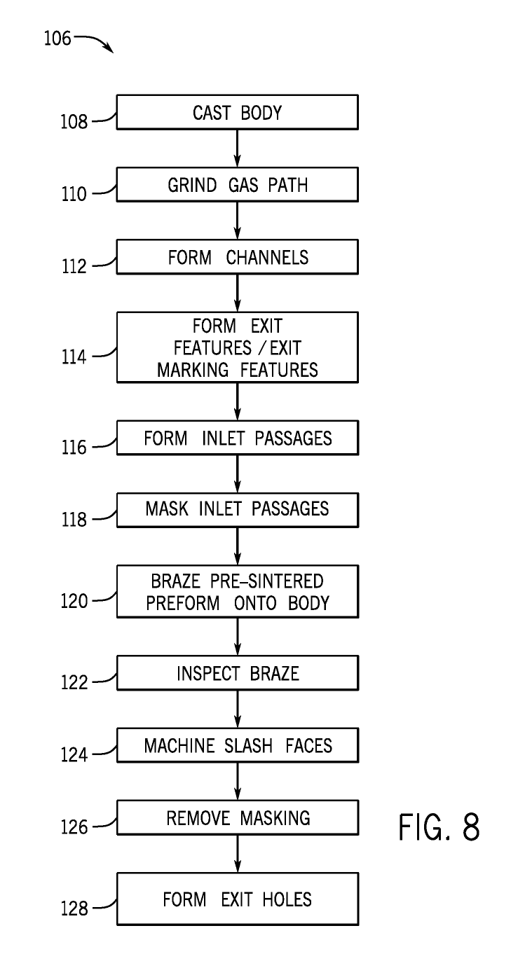

FIG. 8 is a flow chart of an embodiment of a method 106 for manufacturing the inner turbine shroud segment 36. The method 106 includes casting the body 42 (block 108). The method 106 also includes grinding a gas path surface onto to the body 42 (block 110). In particular, the lateral side 54 that is configured to be oriented toward the hot gas flow path 47 may be grinded into an arcuate shape in the circumferential direction 34 between the first and second side edges 48, 50 and/or in the axial direction 30 between the leading and trailing edges 44, 46. The method 106 further includes forming (e.g., machining, electrical discharge machining, etc.) the channels 74 into the lateral side 54 of the body 42 and target features into the free ends of the end portions (block 112). The target features enable the metering features to intersect the channels 74. The method 106 yet further includes forming (e.g., machining, electrical discharge machining, etc.) the exit features or exit marking features (e.g., bridge portion 102) that indicate where exits holes 105 should be drilled or electrical discharge machined in the second end portion 82 of the channels 74 (block 114). The method 106 still further includes forming (e.g., machining, electrical discharge machining, etc.) the inlet passages 94 from the lateral 52 to the free ends 80 of the hook-shaped portions 78 of the first end portions 76 of the channels 74 (block 116). The method 106 includes masking the openings or apertures 92 of the inlet passages 94 (block 118) to block debris from getting within the channels 74 during manufacture of the inner turbine shroud segment 36. The method 106 includes brazing the PSP layer 58 onto the lateral side 54 (block 120) so that the first surface 60 of the PSP layer 58 together with the body 42 defines (e.g., encloses) the channels 74 and the second surface 62 of the PSP layer 58 interfaces with the hot gas flow path 47. In certain embodiments, as an alternative to the PSP layer 58 a non-PSP metal sheet may be disposed on the lateral side 54 that together with the body 42 defines the channels 74. In certain embodiments, as an alternative to the PSP layer 58, a barrier coating or TBC bridging may be utilized to enclose the channels 74 within the body 42. The method 106 also includes inspecting the brazing the of the PSP layer 58 to the body 42 (block 122). The method 106 yet further includes machining the slash faces (e.g., side edges 48, 50) (block 124). The method 106 still further includes removing the masking from the openings 92 of the inlet passages 94 (block 126). The method 106 even further includes forming (e.g., machining, electrical discharge machining, etc.) the exit holes 105 of the second end portions 82 of the channels 74 to enable the cooling fluid to exit the side edges 48, 50 (block 128). In certain embodiments, the channels 74, the metering features, and the inlet passages 94 may be cast within the body 42.

Technical effects of the disclosed embodiments include manufacturing multiple cooling channels to provide cooling flows (e.g., air) to the turbine blades to reduce the premature failure of blades and associated components. The cooling channels may be formed on an inner shroud segment and/or an outer shroud segment. The cooling channels and associated targets (e.g., free ends) may be formed by suitable techniques, such as electrical discharge machining. The cooling channels include free ends (e.g., targets) disposed on a hook-shaped portion. The free ends couple to the inlet passages to receive a cooling fluid from the cavity to cool the turbine shroud.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A shroud segment, comprising:
a body including a leading edge, a trailing edge, a first side edge, a second side edge, and a pair of opposed lateral sides between the leading and trailing edges and the first and second side edges, wherein a first lateral side of the pair of opposed lateral sides is configured to interface with a cavity having a cooling fluid, and a second lateral side of the pair of opposed lateral sides is configured to interface with a hot gas flow path;
a first channel disposed within the body, wherein the first channel comprises a first end portion and a second end portion, the first end portion is disposed adjacent the first side edge and the second end portion is disposed adjacent the second side edge; and
a second channel disposed within the body, wherein the second channel comprises a third end portion and a fourth end portion, the third end portion is disposed adjacent the first side edge and the fourth end portion is disposed adjacent the second side edge; and
wherein the first and second channels are configured to receive the cooling fluid from the cavity to cool the body, and wherein the first end portion and the fourth end portion each comprises a portion having a free end, and each free end has width in a direction from the leading edge to the trailing edge greater than an adjacent portion of the portion coupled to the free end.

2. The shroud segment of claim 1, wherein each free end is configured to couple to a respective inlet passage extending in a radial direction from the free end to the first lateral side, wherein each respective inlet passage is configured to provide the cooling fluid from the cavity to the respective channel.

3. The shroud segment of claim 2, wherein the width of the respective inlet passages is less than the width of the respective free ends.

4. The shroud segment of claim 2, wherein the first and second channels are electrical discharge machined into the body.

5. The shroud segment of claim 2, wherein the respective inlet passages are electrical discharge machined into the body.

6. The shroud segment of claim 1, wherein the second end portion and the third end portion is configured to couple to a respective outlet passage extending in a radial direction to the second lateral side, wherein each respective outlet passage is configured to discharge cooling fluid from body of the inner shroud segment into the hot gas flow path.

7. The shroud segment of claim 1, wherein each free end comprises an elliptic shape and each adjacent portion comprises a straight portion.

8. The shroud segment of claim 1, wherein the shroud segment is configured to be utilized in a gas turbine engine.

9. A gas turbine engine, comprising:
a compressor;
a combustion system; and
a turbine section, comprising:
a casing;
an outer shroud segment coupled to the outer casing;
an inner shroud segment coupled to the outer shroud segment to form a cavity configured to receive a discharged cooling fluid from the compressor,
wherein the inner shroud segment comprises:
a body including a leading edge, a trailing edge, a first side edge, and a second side edge, a pair of opposed lateral sides between the leading and trailing edges and the first and second side edges, wherein a first lateral side of the pair of opposed lateral sides is configured to interface with the cavity, and a second lateral side of the pair of opposed lateral sides is configured to interface with a hot gas flow path;
a plurality of channels disposed within the body and extending from adjacent the first side edge to adjacent the second side edge, wherein each channel of the plurality of channels comprises a first end portion having a portion and a second end portion; and
wherein the plurality of channels are configured to receive a cooling fluid from the cavity to cool the body, and wherein the first end portions each comprises a portion having a free end, and each free end has width in a direction from the leading edge to the trailing edge greater than an adjacent portion of the portion coupled to the free end.

10. The gas turbine engine of claim 9, wherein each free end is configured to couple to a respective inlet passage extending in a radial direction from the free end to the first lateral side, wherein each respective inlet passage is configured to provide a cooling fluid from the cavity to the respective channel.

11. The gas turbine engine of claim 10, wherein the width of the respective inlet passages is smaller than the width of the respective free ends.

12. The gas turbine engine of claim 10, wherein the respective inlet passages are electrical discharge machined into the body.

13. The gas turbine engine of claim 9, wherein each free end comprises an elliptic shape and each adjacent portion comprises a straight portion.

14. The gas turbine engine of claim of claim 9, wherein each second end portion is coupled to a respective outlet passage extending, wherein each respective outlet passage is configured to discharge the cooling fluid from the body of the inner shroud segment.

15. The gas turbine engine of claim 9, comprising a pre-sintered perform layer brazed onto the second lateral side, wherein the pre-sintered perform layer comprises a first surface configured to interface with the hot gas flow path and a second surface configured to interface with the body to define the plurality of channels.

16. The gas turbine engine of claim 9, comprising a plurality of inner shroud segments circumferentially disposed about a rotational axis of the turbine section.

17. The gas turbine engine of claim 9, wherein the portion comprises a target feature.

18. The gas turbine engine of claim 9, wherein the portion comprises a radius of approximately 1.14 mm.

19. A shroud segment for use in a turbine section of a gas turbine engine, comprising:
a body including a leading edge, a trailing edge, a first side edge, a second side edge, and a pair of opposed lateral sides between the leading and trailing edges and the first and second side edges, wherein a first lateral side of the pair of opposed lateral sides is configured to interface with a cavity having a cooling fluid, and a second lateral side of the pair of opposed lateral sides is configured to interface with a hot gas flow path;
a first channel disposed within the body, wherein the first channel comprises a first end portion and a second end portion, the first end portion is disposed adjacent the first side edge and the second end portion is disposed adjacent the second side edge; and
a second channel disposed within the body, wherein the second channel comprises a third end portion and a fourth end portion, the third end portion is disposed adjacent the first side edge and the fourth end portion is disposed adjacent the second side edge; and
wherein the first and second channels are configured to receive the cooling fluid from the cavity to cool the body, and wherein the first end portion and the fourth end portion each comprises a portion comprising a free end, and having an elliptic shape and a straight portion adjacent to the free end.

20. The shroud segment of claim 19, wherein each free end is configured to couple to a respective inlet passage extending in a radial direction from the free end to the first lateral side, wherein each respective inlet passage is configured to provide the cooling fluid from the cavity to the respective channel.
